(19) United States
(12) Patent Application Publication
(10) Pub. No.: US 2011/0175783 A1
(43) Pub. Date: Jul. 21, 2011

(54) MULTILAYER ANTENNA

(75) Inventor: Jung Kim, Jeonju-si (KR)

(73) Assignee: Neopulse Co., Ltd., Suwon-si, Gyeonggi-do (KR)

(21) Appl. No.: 12/998,231

(22) PCT Filed: Feb. 9, 2009
(86) PCT No.: PCT/KR2009/000599

§ 371 Date: Mar. 29, 2011

(30) Foreign Application Priority Data
Sep. 30, 2008 (KR) 10-2008-0096234
Dec. 26, 2008 (KR) 10-2008-0134807

(51) Int. Cl. H01Q 1/36; H01Q 21/00

(52) U.S. Cl. 343/810; 343/893

(57) ABSTRACT

The present invention relates to a multilayer antenna which is capable of improving communication performance by reducing an antenna size and increasing an antenna gain by improving performance of a plurality of antenna elements disposed adjacent to each other using a coupling. The multilayer antenna includes an antenna plate for coupling is arranged over plurality of antenna strips in a manner to be isolated from the antenna strips. With this configuration, the multilayer antenna is capable of increasing channel capacity and data transfer rate by reducing an antenna size and intercepting mutual interference and noise between the antenna elements.

### CROSS-REFERENCE TO RELATED APPLICATION

This application claims the benefit of Korean Application No. 10-2008-0096234, filed on Sep. 30, 2008, and Korean Application No. 10-2008-0134807, filed on Dec. 26, 2008, with the Korean Intellectual Property Office, the disclosure of which is incorporated herein by reference.

### BACKGROUND OF THE INVENTION

1. Field of the Invention

The present invention relates to a multilayer antenna which is capable of improving communication performance by reducing an antenna size and increasing an antenna gain by improving performance of a plurality of antenna elements disposed adjacent to each other using a coupling.

2. Description of the Related Art

A wideband wireless communication system, such as WiMax, 802.11x, LTE(Long Term Evolution) and the like, which is catching on as the next generation communication system, has several problems which have to be solved to provide the same performance as or performance superior to wired voice and data communications.

One of techniques for reducing a difference between such wireless communication and wired communication is an MIMO (Multiple-Input, Multiple-Output) system using a plurality of antennas. MIMO is a new and attractive approach to solve problems of wireless communication, such as attenuation of signals, increase of interference, restriction on spectrums, and the like.

MIMO provides antenna diversity using a plurality of antenna to thereby allow for doubling a data processing speed and increasing a frequency band and reliability without requiring additional radio frequencies.

MIMO is an innovative multidimensional approach to transmit/receive two or more individual data streams through one wireless channel and a system can provide more than double a data transfer speed per channel through this approach. By allowing a plurality of data streams to be transmitted at once, MIMO increases wireless data capacity several fold without using additional frequency spectrums.

The maximum processing speed of an MIMO system can be increased by a multiple corresponding to the number of signal streams to be transmitted through a wireless channel. An MIMO signal is called ‘multidimensional signal’ since a plurality of signals is transmitted from different radio devices and antennas, respectively.

However, as MIMO providing the above merits requires the plurality of antennas, for example, a mobile communication terminal requiring a plurality of antennas to be mounted in a space relatively smaller than a base station may produce an inter-antenna coupling effect that distorts or cancels out signals, which may result in deterioration of receipt sensitivity. That is, in this case, a flow of induced current happens between the plurality of antennas and weakens signal sensitivity, which may result in disconnection of data communication and hence difficulty in obtaining the merits of MIMO system.

Examples of systems employing such a plurality of antennas include a tunable antenna system which selects and uses a plurality of antennas with different bands set, a smart antenna system having a configuration similar to that of MIMO, etc, but these systems still have the above-mentioned problems.

FIG. 1 shows an example conventional single layer monopole antenna array provided with a plurality of antennas, where a pair of symmetrical monopole antenna strips 11 is formed in a plane of carrier 10.

As shown, when monopole antennas are arranged adjacent to each other in a symmetrical manner, since an antenna signal at one antenna is induced in another adjacent antenna, thereby reducing antenna sensitivity, length of antenna is substantially reduced, which results in deterioration of communication performance.

For example, if the shown antenna array is configure to operate in a 2.5 GHz band, the antenna strips 11 are required to have length of about 30 mm. However, if the antenna strips are configured to have the length of 30 mm, an actual resonant frequency of the antenna array becomes more than 2.5 GHz, which results in substantial reduction of antenna length. That is, when an antenna operating at the 2.5 GHz is required, the antenna length has to be further extended.

FIG. 2 shows a substantial transmission line characteristic of an antenna designed to operate at a 2.5 GHz. It can be seen from this figure that a resonance happens at a frequency higher than 2.5 GHz, thereby reducing antenna length.

FIG. 3 shows an equivalent circuit of the antenna array configured as shown in FIG. 1. It can be seen from this figure that, in the antenna array including two antenna elements, an antenna signal at one antenna element may be induced to another adjacent antenna element, but there is no means to prevent this effect.

Accordingly, when the plurality of antennas is configured to have the single layer structure as mentioned above, the antenna length has to be further extended and a distance between the antennas has to be sufficiently secured, which results in increase of a space for antenna configuration. In addition, an antenna gain is also reduced by any mutual signal interference, which results in decrease in channel capacity and data transfer rate.

In the meantime, in recent years, there appears new antenna systems configured to reduce interference between adjacent antennas. For example, techniques for adding a line to short the antennas between the antennas or adding a particular signal processing circuit between the antennas are being experimentally applied to the new antenna systems. However, the scheme of directly shorting the antennas has a critical problem of significant reduction of bandwidth due to change of band characteristics of the antennas, and the scheme of adding the signal processing circuit has a problem of difficulty in actual application due to complicated additional configuration.

### SUMMARY OF THE INVENTION

Accordingly, it is an object of the present invention to provide a multilayer antenna with a plurality of adjacent antenna elements, which is capable of increasing channel capacity and data transfer rate by reducing an antenna size and intercepting mutual interference and noise between the antenna elements.

It is another object of the present invention to provide a multilayer antenna which is capable of ensuring an effect of improvement of antenna characteristics for an overall frequency band by alleviating mutual interference for the overall frequency band while maintaining the antenna characteristics with the band unchanged.

It is still another object of the present invention to provide a multilayer antenna which is capable of implementing a tunable antenna system by adjusting an antenna resonance point for each of a plurality of antenna ports in various ways by adjusting position and arrangement of a multi-layered structure in an application of an antenna plate.

To achieve the above objects, according to an aspect of the invention, there is provided a multilayer antenna comprising: one or more antenna strips which are connected to individual power feeders and are arranged adjacent to each other; and an antenna plate which includes couplers coupled respectively to the one or more antenna strips and a connection connecting the couplers each other and is arranged in a manner to be isolated from the antenna strips.

Preferably, the multilayer antenna further comprises an insulating layer interposed between the antenna strips and the antenna plate.

According to anther aspect of the invention, there is provided a multilayer antenna comprising: a first layer which is formed on a substrate and has one or more antenna strips formed therein to secure power feeding and electrical length of an antenna; a second layer which isolates the first layer from a different layer; and a third layer which is isolated from the first layer by the second layer and has a single conductive antenna radiator formed therein, the antenna radiator including couplers coupled respectively to the antenna strips of the first layer.

According to an embodiment of the present invention, a multilayer antenna with a plurality of adjacent antenna elements is capable of increasing channel capacity and data transfer rate by reducing an antenna size and intercepting mutual interference and noise between the antenna elements.

According to an embodiment of the present invention, a multilayer antenna is capable of ensuring an effect of improvement of antenna characteristics for an overall frequency band by alleviating mutual interference for the overall frequency band while maintaining the antenna characteristics with the band unchanged.

According to an embodiment of the present invention, a multilayer antenna is capable of implementing a tunable antenna system by adjusting an antenna resonance point for each of a plurality of antenna ports in various ways by adjusting position and arrangement of a multi-layered structure in an application of an antenna plate.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a view showing a configuration of a conventional single layer monopole antenna system;

FIG. 2 is a graph showing transmission line characteristics of the conventional single layer monopole antenna system;

FIG. 3 is an equivalent circuit diagram of the conventional single layer monopole antenna system;

FIG. 4 is a perspective view of a multilayer antenna according to an embodiment of the present invention;

FIG. 5 is a sectional view of a multilayer antenna according to an embodiment of the present invention;

FIG. 6 is a graph showing transmission line characteristics of the multilayer antenna according to an embodiment of the present invention;

FIG. 7 is a view showing an antenna structure and its equivalent circuit of the multilayer antenna according to an embodiment of the present invention;

FIG. 8 is an equivalent circuit diagram of a coupling-structured antenna;

FIGS. 9 to 11 are perspective views of multi-layer antennas according to several embodiments of the present invention;

FIG. 12 is a multi-port equivalent circuit diagram of a multilayer antenna according to an embodiment of the present invention;

FIG. 13 is a conceptual view for explaining variableness of characteristics of a multilayer antenna according to an embodiment of the present invention;

FIGS. 14 and 15 are equivalent circuit diagrams showing a flow of induced current of a multilayer antenna according to an embodiment of the present invention;

FIG. 16 is a graph showing a S-parameter characteristic of a multilayer antenna according to an embodiment of the present invention;

FIG. 17 is a graph showing a S-parameter characteristic of a multilayer antenna according to another embodiment of the present invention;

FIG. 18 is a graph showing an irradiation pattern of a high isolation multilayer antenna according to the embodiment shown in FIG. 17.

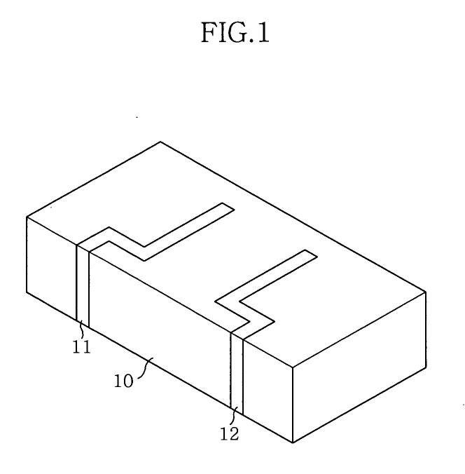

### DETAILED DESCRIPTION OF THE PREFERRED EMBODIMENT

Hereinafter, a multilayer antenna according to preferred embodiments of the present invention will be described with reference to the accompanying drawings.

The embodiments to be shown below will be illustrated by way of example of MIMO (Multiple-Input, Multiple-Output) antenna, but may be applied to a smart antenna or the like having a structure similar to the MIMO antenna, or other antennas which are capable of reducing mutual interference between adjacent antenna elements.

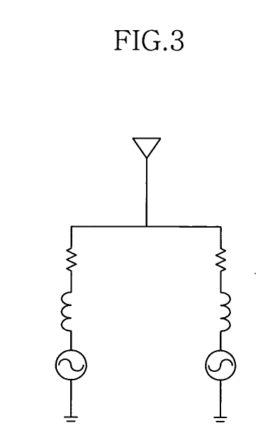

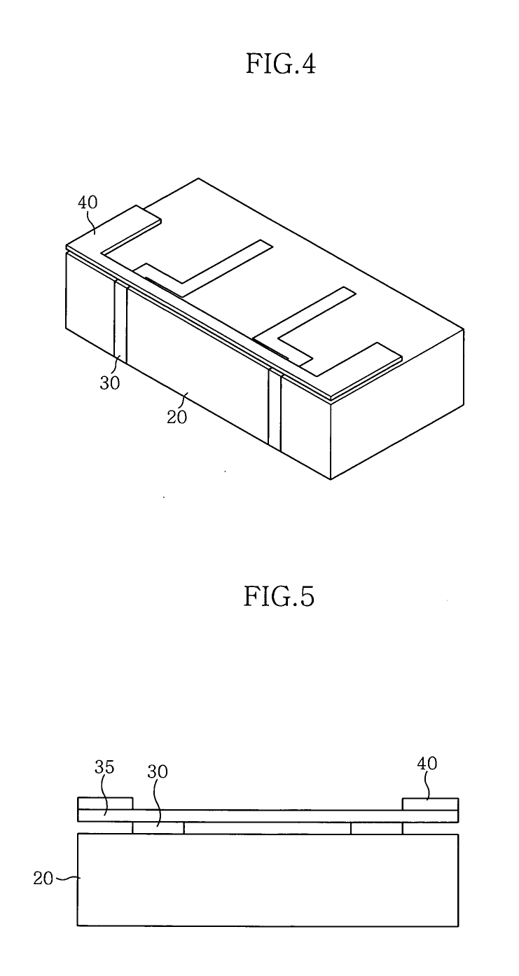

FIG. 4 is a perspective view of a multilayer antenna according to an embodiment of the present invention. As shown, a multi-layer monopole antenna system is constructed by arranging a pair of antenna strips 30 on a carrier 20 in the same way as the single layer monopole antenna system shown in FIG. 3 and placing an antenna plate 40 as an upper layer over the antenna strips 30, with an air layer formed between the antenna plate 40 and the antenna strips 30.

FIG. 5 is a sectional view of a portion of FIG. 4, showing the configuration of FIG. 4 in more detail. As shown in FIG. 5, the antenna strips 30 are arranged on the carrier 20, an insulating layer 35, as a gap filled with dielectric material or air for insulation, is formed on the antenna strips 30, and the antenna plate 40 is formed on the insulating layer 35.

Such an isolation configuration may be freely modified in various ways in addition to the shown configuration. For example, the antenna strips 30 may be formed within the carrier 20, or the antenna plate 40 may be first formed on and isolated from the carrier 20 and then the antenna strips 30 may be formed on the antenna plate 40. Alternatively, both side ends of the antenna strips 30 and the antenna plate 40 may be arranged in an isolated manner on the same plane and only a portion connecting both side ends of the antenna plate 40 may be arranged in a manner to be isolated from the antenna strips 30. It should be here noted that at least portions of the antenna strips 30 and the antenna plate 40 have to have a multi-layer structure and maintain a structural characteristic of electrical isolation from each other.

Upon forming the multi-layer antenna structure where the antenna plate 40 is arranged in an isolated manner on the single layer antenna structure as shown in FIGS. 4 and 5, it is possible to prevent a signal at one antenna element from being induced into another adjacent antenna element by a coupling effect between the antenna strips 30 and the separated antenna plate 40. In the meantime, a capacitance component is formed between the antenna strips 30 and the antenna plate 40, which results in reduction of physical length of antenna elements.

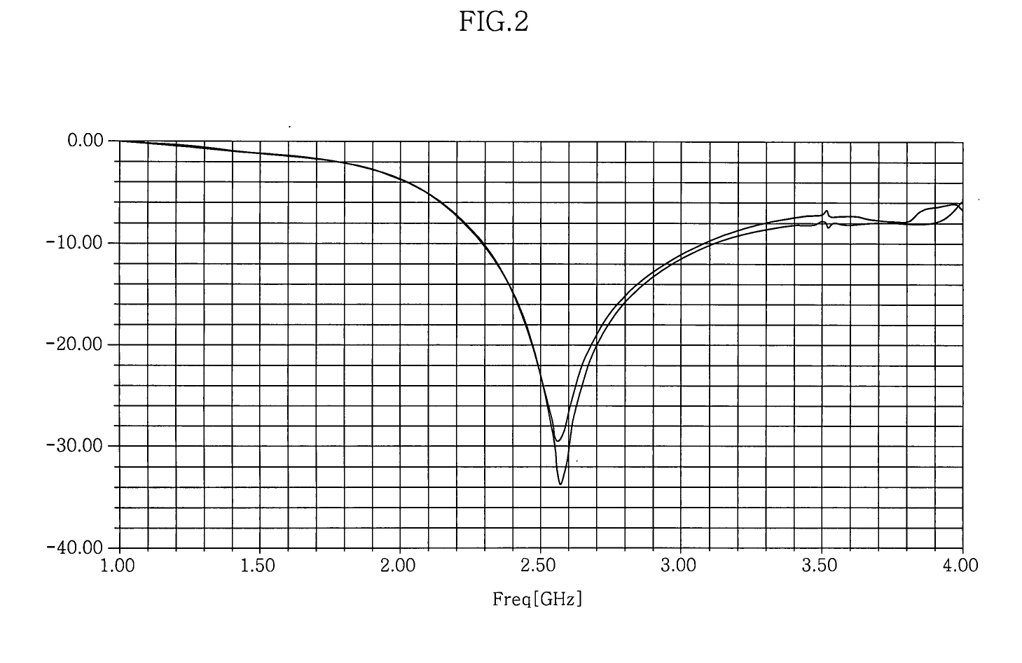

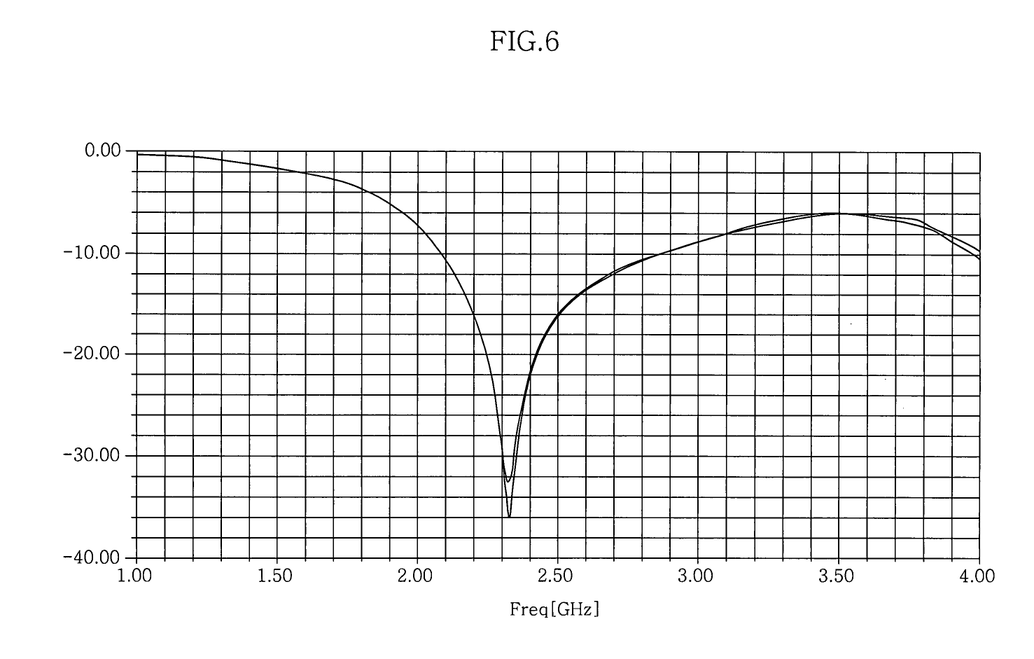

FIG. 6 is a graph showing transmission line characteristics of the multilayer antenna when the length of the antenna strips shown in FIG. 4 is set to be 30 mm. It can be seen from this graph that a resonance occurs at about 2.3 GHz when antenna plate 40 as shown in FIG. 4 is applied, while a resonance occurs at 2.57 GHz as shown in the graph of FIG. 2 in case of a single antenna system. That is, it can be confirmed that a resonance point moves by about 200 MHz due to a capacitance component between the antenna strips 30 and the antenna plate 40. This shows that it is possible to reduce physical length of a monopole antenna, a dipole antenna, a planar inverted-F antenna (PIFA) or a patch antenna, which may be equipped within a potable device.

As a result, as illustrated in FIGS. 4 and 5, when an antenna system is configured to have a multi-layer structure where an antenna plate isolated by an insulating layer is applied to a single layer antenna structure, length of antenna strips on a carrier can be reduced, and length of the carrier can be reduced accordingly, which results in substantial reduction of total volume of the antenna system.

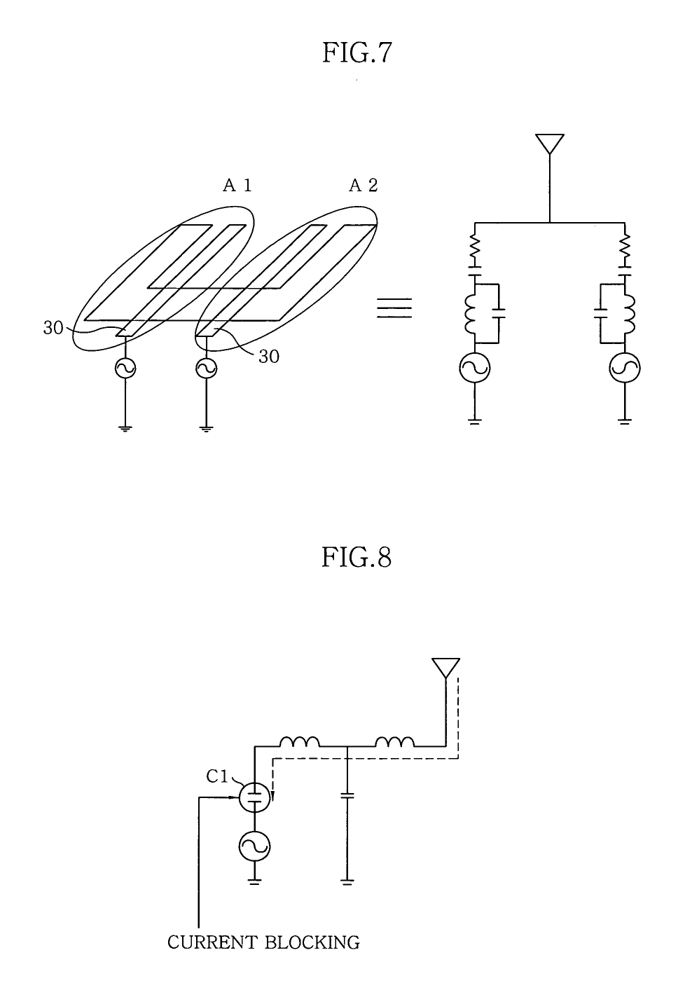

FIG. 7 is a schematic view and its equivalent circuit of the multilayer antenna for explaining the operation principle of the multi-layer antenna structure shown in FIGS. 4 and 5. First, a pair of antenna elements fed with power by the antenna strips 30 is defined, and the antenna plate 40 having both side ends arranged in the outside of and in parallel to the antenna strips 30 and connections to interconnect the both side ends in a direction perpendicular to the antenna strips 30 is configured to be isolated from the antenna strips 30, thereby operating as a first antenna A1 and a second antenna A2. If the antenna system is considered as a single antenna, power feeds of the antennas A1 and A2 may be called first and second ports, respectively.

The antenna strips 30 conduct power feeding and emission simultaneously, and the antenna plate 40 conducts an emission function and an induced current canceling function simultaneously.

In the equivalent circuit shown in the right side of the figure, pairs of capacitor and inductor formed in parallel in the left and right sides correspond to the first antenna Al and the second antenna A2 operating as individual antennas by a coupling, respectively, and upper resistors and upper capacitors (corresponding to those indicated by circles in the left side of the figure) correspond to the connections to interconnect the both side ends (i.e., couplers) of the antenna plate 40, respectively.

Currents emitted from the first antenna Al and second antenna A2 are reflected by serially-connected capacitors (corresponding to those indicated by the above circles) correspond to the connections of the antenna plate 40, and the mutually-induced currents are cancelled each other by a symmetrical structure. That is, the serially-connected capacitors prevent an undesired signal induced from one antenna from being introduced into another adjacent antenna. Such a circuit configuration is equivalent to a general noise removal circuit for use in an active antenna or the like, which provides an effect of enhancing an active performance of terminals.

FIG. 8 is an equivalent circuit diagram of a coupling-structured antenna, showing that a capacitor C1 connected in series to a power feed performs an induced current blocking function, i.e., a noise removal function. This configuration of the multilayer antenna can be applied to the equivalent circuit of the multilayer antenna shown in FIG. 7 according to an embodiment of the present invention, which provides the induced current blocking/noise removal function to thereby provide an effect of enhancing an active performance of terminals.

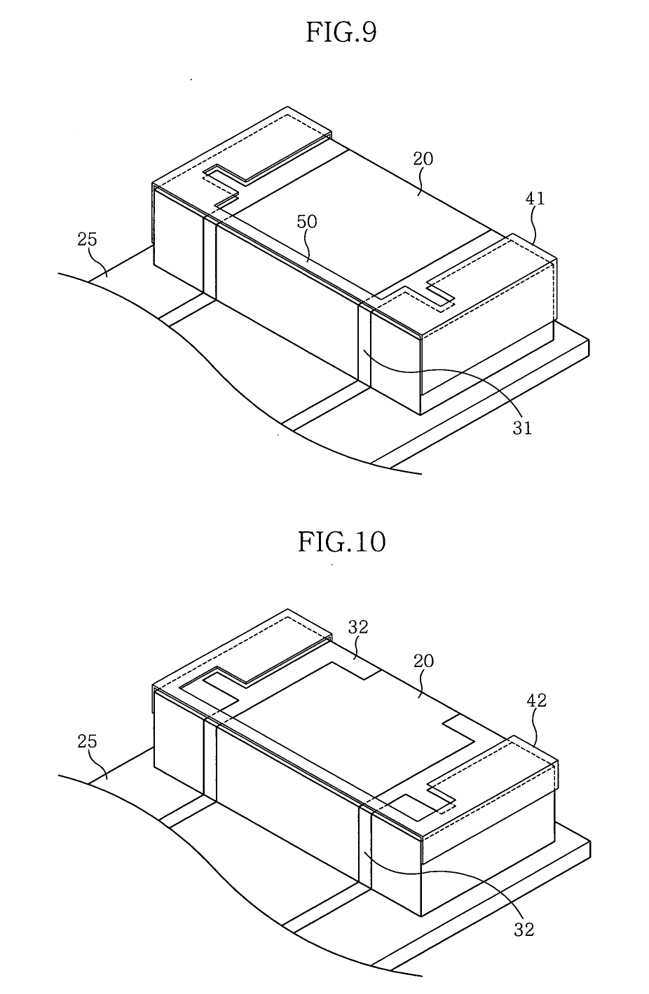

FIGS. 9 to 11 show example multilayer antennas according to several embodiments of the present invention.

FIG. 9 shows a configuration where length of adjacent sides of antenna strips 31 and an antenna plate 41 is lengthened. As shown, the antenna strips 31 separated by a certain distance from each other are arranged on a carrier on a substrate, and a ‘⊂’-like antenna plate 41 is isolated from and arranged over the antenna strips 31 and has both ends (couplers) arranged in the outside of the antenna strips 31 and an connection 50 to interconnect the both ends, which is arranged perpendicular to the antenna strips 31. The antenna strips 31 and the antenna plate 41 may take other various structures including a curved structure depending on a structure of the carrier 20, and in particular, the antenna plate 41 may take modified shapes instead of the ‘⊂’-like shape.

The antenna strips 31 and the antenna plate 41 form a pair of symmetrical antennas are composed of a pair of strip electrodes and act as different antenna power feeders through which different signals are provided, as well as different radiating bodies. Both ends of the antenna plate 41 adjacent to the antenna strips 31 act as antennas fed with power by a coupling, and at the same time, an adjacent antenna-induced signal is blocked and noise is removed by one end of the connections 50 interconnecting the both ends.

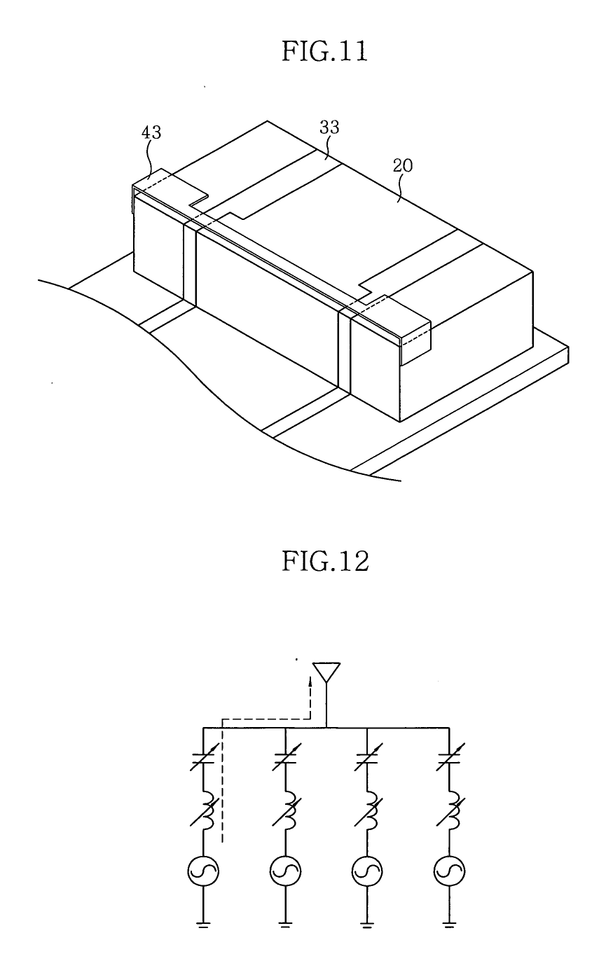

FIG. 10 shows antenna strips 32 and an antenna plate 42 configured in a more cubic manner to allow a multi-band characteristic, which are a modification of the antenna strips and the antenna plate shown in FIG. 9. FIG. 11 shows a simplified construction of antenna strips 33 and an antenna plate 43 to allow a more effective band characteristic.

As illustrated in FIGS. 9 to 11, a multi-layer antenna structure including a first layer in which antenna strips are formed, a second layer defined as an isolation space, and a third layer defined as an antenna plate may be varied in various cubic manners (for example, a shape closing a carrier or a shape in which the first layer is formed in a cubic carrier, etc.), and an arrangement scheme may be altered in such a manner that the third layer, the second layer and the first layer are arranged on a substrate in order.

In the meantime, since an antenna line characteristic can be adjusted depending on an isolation distance between the antenna plate and the antenna strips, a size of a coupler (both ends) of the antenna plate, a length of an adjacent portion of the antenna strips and the antenna plate, a distance between the antenna strips, a structure of the antenna strips, etc., an appropriate arrangement of the antenna strips and the antenna plate is required.

In addition, the multilayer antenna of the present invention may be configured to have a general internal antenna structure such as a monopole antenna, a dipole antenna, PIPA or a patch antenna.

FIG. 12 is a simplified circuit diagram for explaining a change of characteristics of individual antennas according to adjustment of the antenna line characteristic. As shown, in a multilayer antenna including a plurality of antennas, when a coupling positions of each antenna is adjusted, characteristics of the antenna system can be adjusted in various ways to allow a resonance point of each antenna to be differently set, in which case switching antennas can be used to form a tunable antenna system.

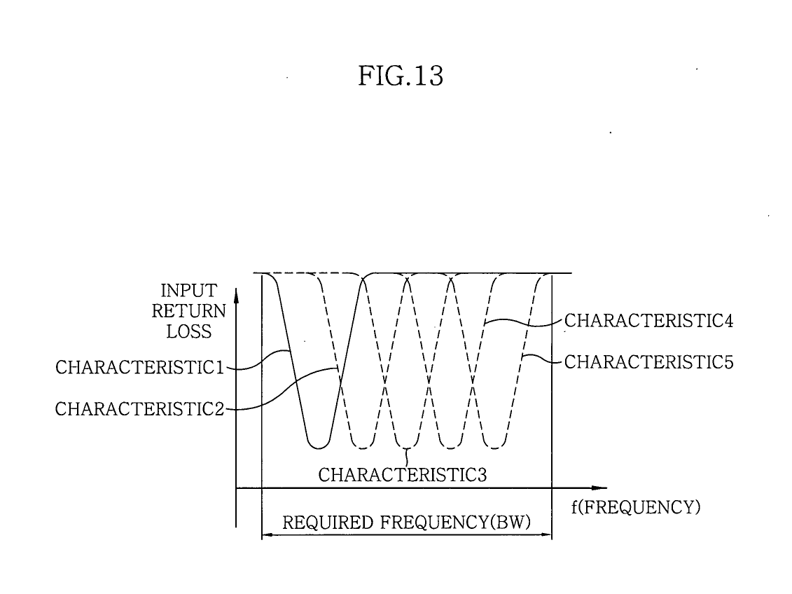

That is, since capacitance and inductance are varied depending on height and dielectric constant of an insulating layer for each antenna and a structure of antenna strips and antenna plate, the multilayer antenna can be configured like the shown equivalent circuit. Adjustment of the capacitance and inductance of the equivalent circuit allow antenna systems having different characteristics as shown in FIG. 13. As a result, by adjusting an arrangement of a plurality of antennas, switching antenna systems having different band characteristics can be easily configured and induced signals can be blocked, which results in improvement of performance of antenna systems using the same band such as MIMO or a smart antenna system.

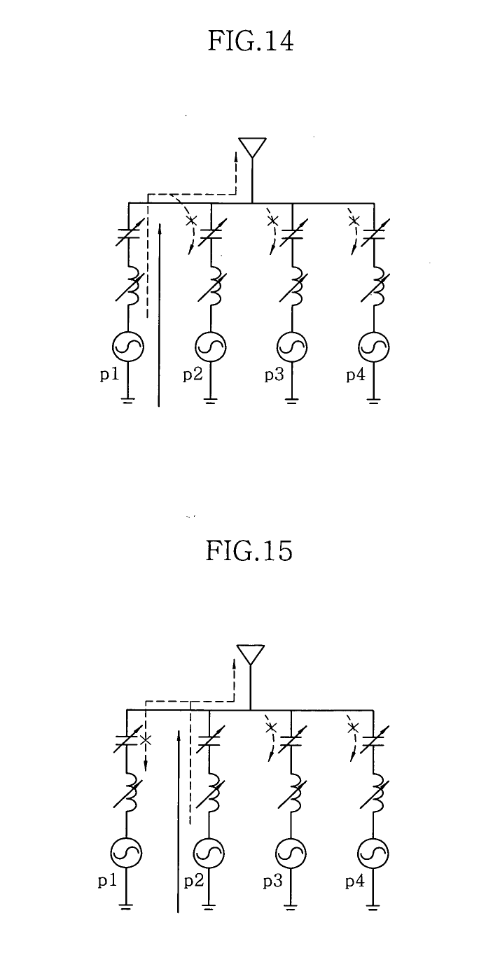

FIGS. 14 and 15 show examples where interference is prevented by blocking a flow of current induced between antennas of a multilayer antenna using multiple ports, i.e., by blocking current induced into a port other than ports induced by an antenna plate.

FIG. 14 shows a flow of current induced from port 1 (P1), where a flow of current of one side port induced from one side coupling antenna is blocked by a capacitance component formed in each coupling antenna so as not to interfere with different ports. Similarly, FIG. 15 shows that a flow of current induced from port 2 (P2) is not induced into different ports.

Accordingly, even in configuring a plurality of antennas, when an multilayer antenna is applied, it is possible to reduce inter-port interference and remove noise, which results in improvement of antenna performance. In addition, by adjusting an arrangement structure of each layer, it is possible to grant an independent characteristic to each antenna, thereby improving active performance of a terminal to which such a multilayer antenna is applied.

In addition, the use of the above-described antenna configuration provides an effect of extension of antenna length due to a coupling effect as well as suppression of inter-antenna interference and prevention of change in antenna band characteristics.

Although single layer antenna structures where a plurality of antennas are directly interconnected or elements are formed between the plurality of antennas in order to suppress interference between adjacent antennas have appeared in recent years, these antenna structures have a problem of reduction in antenna bandwidth due to direct interconnection of antennas.

On the contrary, the multilayer antenna according to the embodiment of the present invention does not reduce a bandwidth defined by antenna strips since an antenna plate is isolated from the antenna strips, which results in improvement of optimal performance if a multilayer antenna requiring even communication characteristics over a wide band is constructed in a small space.

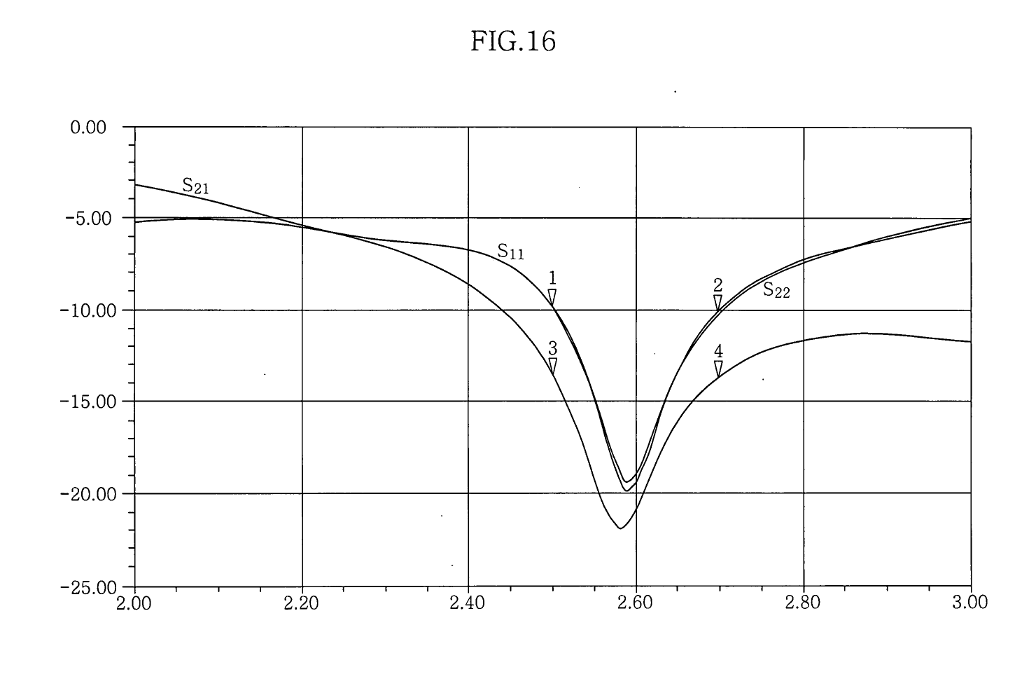

FIG. 16 is a graph showing a S-parameter characteristic of a multi-layer MIMO antenna system according to an embodiment of the present invention when the antenna system has two symmetrical monopole antennas. It can be seen from this graph that band characteristics indicated by curves S11 and S22 showing reflection characteristics of the monopole antennas are less than −10 dB in a use band range of 2.5 GHz to 2.7 GHz. On the other hand, it can be seen from this graph that a curve S21 showing a mutual interference characteristic of the monopole antennas has an excellent characteristic of less than −13 dB in the corresponding use band range.

In general, in that a S21 reflection characteristic in a use band is more than 0 dB when monopole antennas are arranged adjacent to each other, −10 dB of the S21 refection characteristic in the use band means little or not effect between a pair of antennas.

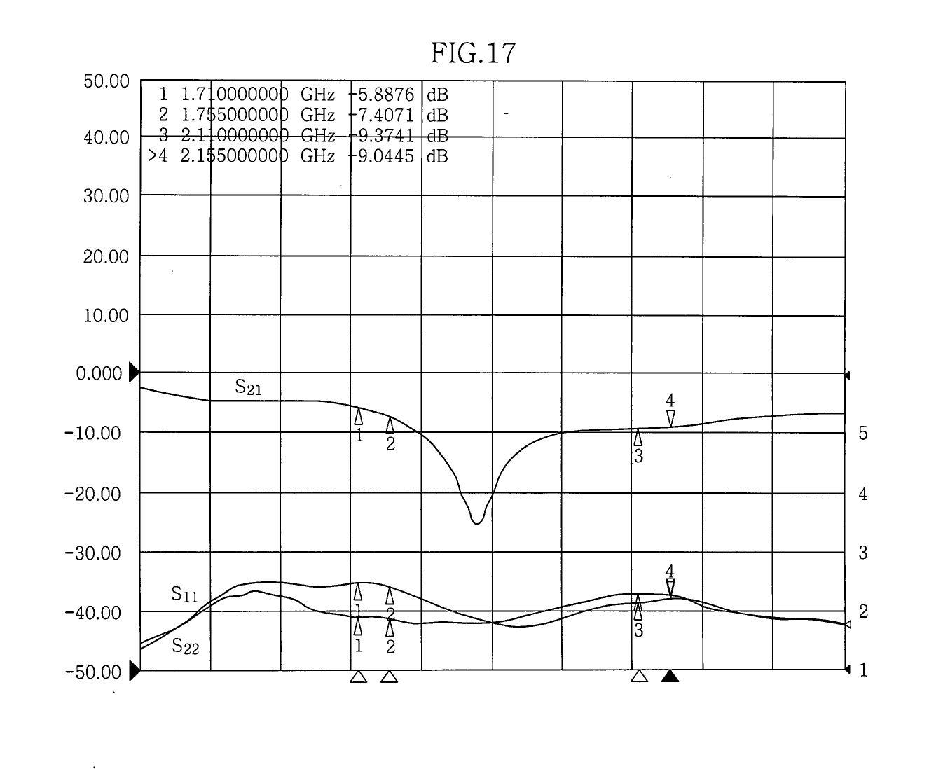

FIG. 17 is a graph showing a S-parameter characteristic of a multilayer antenna according to another embodiment of the present invention, where S21 is depicted with a dB scale and S11 and S22 are depicted with VSWR (Voltage Standing Wave Ratio)(indicated in the right side of the graph).

As shown, S11 and S22 have VSWRs of less than 2.5 and S21 shows a characteristic of less than −7 dB in a use band of 1.7 to 2.1 GHz, which means little or not inter-antenna interference.

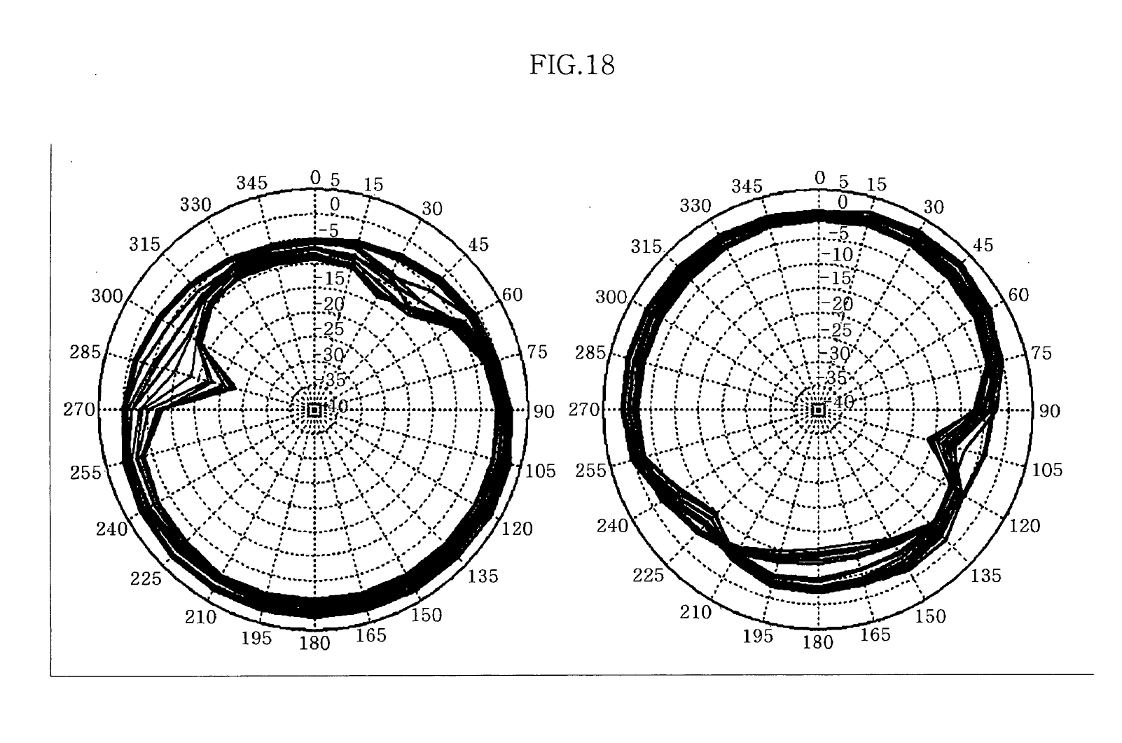

FIG. 18 shows an H planar pattern for the embodiment of FIG. 17, where the left side represents a first antenna and the right side represents a second antenna. It can be seen from this pattern that the first and second antennas are in symmetry without interference with each other.

Accordingly, just by arranging an antenna plate in a manner to be isolated from an antenna strip plane in a multilayer antenna, the embodiment of the present invention is capable of adjustment and improvement of characteristic of the antenna system and individual adjustment of characteristics of a plurality of antennas, as well as reduction of antenna length and prevention of mutual interference between the antennas without a band loss.

While the present invention has been particularly shown and described with reference to exemplary embodiments thereof, it will be understood by those skilled in the art that various changes in form and details may be made therein without departing from the spirit and scope of the present invention. The exemplary embodiments are provided for the purpose of illustrating the invention, not in a limitative sense. Thus, it is intended that the present invention covers the modifications and variations of this invention provided they come within the scope of the appended claims and their equivalents.

What is claimed is:

1. A multilayer antenna comprising:
one or more antenna strips which are connected to individual power feeders and are arranged adjacent to each other; and
an antenna plate which includes couplers coupled respectively to the one or more antenna strips and a connection connecting the couplers each other and is arranged in a manner to be isolated from the antenna strips.

2. The multilayer antenna according to claim 1, further comprising an insulating layer interposed between the antenna strips and the antenna plate.

3. The multilayer antenna according to claim 1, wherein the antenna strips are formed in a cubic shape on a carrier.

4. The multilayer antenna according to claim 1, wherein the couplers of the antenna plate are arranged in a manner to conform to at least one side of the antenna strips.

5. The multilayer antenna according to claim 1, wherein an arrangement of the antenna plate and the antenna strips is determined depending on antenna band characteristics defined by the couplers of the antenna plate and the antenna strips.

6. The multilayer antenna according to claim 5, wherein arrangements of the couplers of the antenna plate and the antenna strips are different for each antenna defined by the antenna strips coupled to the couplers of the antenna plate.

7. The multilayer antenna according to claim 5, wherein arrangements of the couplers of the antenna plate and the antenna strips are the same for each antenna defined by the antenna strips coupled to the couplers of the antenna plate.

8. The multilayer antenna according to claim 5, wherein the antenna band characteristic of each antenna defined by the couplers of the antenna plate and the antenna strips coupled to the couplers is varied depending on an isolation distance between the antenna plate and the antenna strips, a size of a coupler of the antenna plate, a length of an adjacent portion of the antenna strips and the antenna plate, a distance between the antenna strips and a structure of the antenna strips.

9. The multilayer antenna according to claim 1, wherein an antenna structure including the antenna plate and the antenna strips is one selected from a group consisting of monopole antenna, dipole antenna, planar inverted-F antenna (PIFA) and patch antenna structures.

10. A multilayer antenna comprising:
a first layer which is formed on a substrate and has one or more antenna strips formed therein to secure power feeding and electrical length of an antenna;
a second layer which isolates the first layer from a different layer; and
a third layer which is isolated from the first layer by the second layer and has a single conductive antenna radiator formed therein, the antenna radiator including couplers coupled respectively to the antenna strips of the first layer.

11. The multilayer antenna according to claim 10, wherein the second layer is formed of an insulator including air or dielectric material and defines an isolation distance between the antenna strips of the first layer and the antenna radiator of the third layer.

12. The multilayer antenna according to claim 11, wherein the second layer has different heights for different antennas defined by the antenna strips of the first layer and the couplers of the antenna radiator of the third layer.

13. The multilayer antenna according to claim 10, wherein the first layer includes antenna strips formed cubically on a cubic substrate.

14. The multilayer antenna according to claim 10, wherein the third layer is formed within a substrate on which the first layer is formed.
